(19) United States
(12) Patent Application Publication
(10) Pub. No.: US 2008/0009314 A1
(43) Pub. Date: Jan. 10, 2008

(54) Mobile Telephone With Am Radio

(75) Inventors: Akira Okamoto, Niigata (JP); Takeshi Ikeda, Niigata (JP)

Correspondence Address: PATENTTM.US, P. O. BOX 82788, PORTLAND, OR, 97282-0788, US

(73) Assignee: NIIGATA SEIMITSU CO., LTD., Niigata (JP)

(21) Appl. No.: 11/718,704

(22) PCT Filed: Nov. 16, 2005
(86) PCT No.: PCT/JP05/21009

§ 371 Date: May 4, 2007

(30) Foreign Application Priority Data
Nov. 18, 2004 (JP) 2004-333872

(51) Int. Cl. H04M 1/00

(52) U.S. Cl. 455/556.1

(57) ABSTRACT

A cellular phone with an AM radio, which can reduce noises, as might otherwise be mixed into the output audio of the AM radio. A cellular phone 100 comprises a cellular phone unit 10 for performing a waiting processing, a line connecting processing and a speech processing, which are performed by transmitting/receiving electric waves between itself and a base station, an AM radio tuner section 20 for receiving the AM radio broadcasts and outputting a demodulated audio signal, and a control section 40 acting as telephone function stopping unit for stopping the operations of the cellular phone unit 10 when the AM radio tuner section 20 is operating.

### TECHNICAL FIELD

The present invention relates to a cellular phone with an AM radio function.

### BACKGROUND ART

Recently, a cellular phone having various functions in addition to the original telephone functions is commonly used. For example, a cellular phone provided with an AM radio broadcast tuner function, an FM radio broadcast tuner function, a television tuner function and the like has been known (for example, see Patent Document 1). With the cellular phone, a user can receive the AM radio broadcast by selecting the AM radio broadcast tuner function. Accordingly, the user does not need to carry the AM radio receiver separately in addition to a cellular phone.

[Patent Document 1]

Japanese Patent Laid-Open No. 2002-101164 (pages 3 to 5, FIGS. 1 to 6)

The cellular phone disclosed in the Patent Document 1 can receive the AM radio broadcast when the cellular phone is in a waiting state in which the it is in a non-calling state. However, it has a problem in that, in case where the AM radio receiver and the cellular phone are actually placed closer, noise is mixed when the AM radio is being received, because a harmonic component of the signal that is regularly sent and received between the cellular phone and the base station overlaps with the receiving band of the AM radio broadcast.

The present invention has been made in view of the abovementioned problem and intends to provide a cellular phone with an AM radio that can reduce noise to be mixed with the output audio of the AM radio.

### DISCLOSURE OF THE INVENTION

In order to solve the abovementioned problem, the cellular phone with an AM radio of the present invention includes a cellular phone unit for performing a waiting processing, a line connect processing and a speech processing performed by sending/receiving an electric wave with a base station, an AM radio tuner unit for receiving the AM radio broadcast and outputting a demodulated audio signal, and a telephone function stopping unit for stopping the operation of the cellular phone unit when the AM radio tuner unit is operating. Particularly, it further includes an operating unit for providing an instruction to commence the reception of the AM radio broadcast by the abovementioned AM radio tuner unit, and, when an instruction to commence the reception is provided by using the operating unit, it stops the operation of the cellular phone unit by a telephone function stopping unit, while commencing the receiving operation of the AM radio broadcast in the AM radio tuner unit. That can eliminate noise to be mixed with an output audio form the AM radio tuner unit along with the operation of the cellular phone unit. Particularly, though the cellular phone needs to be turned off in public facilities such as on the train or in the hospital, only the operation of the cellular phone unit can be turned off when the AM radio broadcast is received in the cellular phone of the invention. Thus, the AM radio can be listened even at the places in which it is forbidden to use the cellular phone.

It is also desirable that an instruction to finish the reception of the AM radio broadcast by the AM radio tuner unit by using the abovementioned operating unit, and that the telephone function stopping unit releases the operation stopped state of the cellular phone unit when the instruction to finish the reception is provided. It is thereby possible to stop the operation of the cellular phone unit only when the AM radio is used and reduce the trouble in releasing the operation stopped state.

It is also desirable that the abovementioned cellular phone unit performs mail sending/receiving processing for sending/receiving mail with a mail server connected via the base station, and that the cellular phone further includes a mail confirmation instruction unit for temporally releasing the operation stopped state of the cellular phone unit at a predetermined time and provides a confirmation instruction to inquire a mail server about the reception of new mail when the AM radio tuner unit is operating and the cellular phone unit stops operating. It is thereby possible to confirm the presence of mail that is sent when the operation of the cellular phone unit is stopped, at a predetermined time. Thus, it can minimize the disadvantages caused by disconnection of the contact by stopping the operation of the cellular phone unit.

It is also desirable that the confirmation instruction by the abovementioned mail confirmation instruction unit is provided repeatedly in predetermined cycles. This makes it possible to correctly confirm the presence of mail with a small time difference from the time when the mail is actually sent.

It is also desirable that the confirmation instruction by the mail confirmation instruction unit is provided according to a manual operation by the user. This makes it possible to reduce the frequency of release the stopped state of the operation of the cellular phone unit when the AM radio broadcast is received, and enables the user to confirm the presence of mail at a required time.

It is also desirable to further include a mail reception notifying unit for notifying that new mail is received if the new mail is received, as a result of inquiring the mail server is inquired about whether new mail is received or not. This makes it possible to certainly know that new mail is received even while the AM radio broadcast is received.

It is desirable that the abovementioned telephone function stopping unit performs operation stopping of the cellular phone unit again, if new mail is not received; and prolongs the stopped state of the operation of the cellular phone unit until predetermined operations are done, if new mail is received, upon inquiring the mail server about whether new mail is received or not. It is thereby not required to release the stopped state of the operation of the cellular phone unit each time when various operations accompanied with the reception of new mail are performed. Thus the various operations can be done in a short time.

It is also desirable that the predetermined operations are the operation of confirming the contents of new mail and the operation of returning mail. It is thereby possible to reduce time for completing the confirmation of the contents of the received mail and the transmission of returning mail to the received mail.

It is also desirable that it further includes a display unit for displaying the operational contents of the cellular phone unit and the operational contents of the AM radio tuner unit, and a display state controlling unit for changing the display state of the display unit when the instruction to commence the reception by using the operating unit is provided. Particularly, it is desirable that the display state controlling unit changes the display state of the display unit to reduce the noise to be mixed with the AM radio tuner unit from the display unit. As the display state of the display unit is changed when the AM radio broadcast is received, it can not only reduce the noise caused by operations of the cellular phone unit but also the noise to be mixed into output audio caused by the display unit as the noise source.

It is also desirable that the display unit is a color liquid crystal display device. The recent mobile devices are often provided with a color liquid crystal display device driven by an active matrix in a TFT type in consideration of improvement in the clearness of display, fast response and the like. It is well known that the color liquid crystal display device is a big noise source to the AM radio tuner in comparison with the liquid crystal display device driven by a segment electrode that performs monochrome display. The noise included in the output audio when the AM radio is used can be reduced by changing a display state in case where the color liquid crystal is used.

It is also desirable that the abovementioned display unit has a plurality of divided regions where display operation can be selectively stopped, and the display state controlling unit stops display operation of a part of the plurality of divided regions when an instruction to commence the reception is provided. That can reduce an area of the display that will be a noise source so that the amount of noise included in the output audio of the AM radio can be reduced.

It is desirable that the abovementioned AM radio tuner unit has a bar antenna whose magnetic core is wound with a coil, and that remaining divided regions in which display operation is not stopped are arranged in one of the spaces separated in the middle of longitudinal in a package having a solid shape oblong in one direction. Alternatively, it is desirable that the abovementioned AM radio tuner unit has a bar antenna whose magnetic core is wound with a coil, and that more than half of the remaining divided regions in which display operation is not stopped are arranged in one of the spaces separated in the middle of longitudinal in a package having a solid shape oblong in one direction. Alternatively, it is desirable that the abovementioned AM radio tuner unit has a bar antenna whose magnetic core is wound with a coil, and that the bar antenna is arranged along the edge of the package that is furthermost from the remaining divided regions in which display operation is not stopped in a package having a solid shape oblong in one direction. That can reduce noise to be mixed with via the bar antenna when the AM radio broadcast is received.

It is also desirable that the abovementioned display unit has a plurality of display regions which are set in different places, and that the display state controlling unit stops display operation of a part of the plurality of display regions when an instruction to commence the reception is provided. That can reduce the area of the display which will be a noise source so that it can reduce the amount of noise included in the output audio of the AM radio.

It is desirable that the abovementioned display state controlling unit stops the display operation for the display region with the biggest area. This makes it possible to eliminate the biggest noise source, thereby effectively reduce the noise.

It is also desirable that the abovementioned display state controlling unit stops the operation of the other display regions except for the display region with the smallest area. This makes it possible to minimize the noise when there are many display regions.

It is desirable that the abovementioned AM radio tuner unit has a bar antenna whose magnetic core is wound with a coil, and that remaining display regions in which display operation is not stopped are arranged in one of the spaces separated in the middle of longitudinal in a package having a solid shape oblong in one direction. Alternatively, it is desirable that the abovementioned AM radio tuner unit has a bar antenna whose magnetic core is wound with a coil, and that more than half of the remaining display regions in which display operation is not stopped are arranged in one of the spaces separated in the middle of longitudinal in a package having a solid shape oblong in one direction. Alternatively, it is desirable that the abovementioned AM radio tuner unit has a bar antenna whose magnetic core is wound with a coil, and that the bar antenna is arranged along the edge of the package that is furthermost from the remaining display regions in which display operation is not stopped in a package having a solid shape oblong in one direction. That can reduce noise to be mixed with via the bar antenna when the AM radio broadcast is received.

It is also desirable that the abovementioned display state controlling unit stops display operation of the display unit when an instruction to commence the reception is provided. This makes it possible to avoid influence of the display unit as a noise source thereby occurrence of noise caused by the display unit can be eliminated.

It is also desirable that channel selection instruction for switching the receiving frequency of the broadcasting wave to be received by the AM radio tuner unit is provided by means of the operating unit, and that the display state controlling unit temporally releases a stopped state of display operation of the display unit when the channel selection instruction is provided. Both effects of improvement of operability and noise reduction can be achieved only by performing the requisite minimum display at the time of the channel selection.

It is also desirable that releasing of the stop state of display operation of the abovementioned display unit is performed on a part of the all display regions of the display unit. This makes it possible to reduce the noise temporally included in the output audio at the time of the channel selection.

It is also desirable to further include an audio output unit for outputting an audio corresponding to an audio signal output from the abovementioned AM radio tuner unit via a speaker, an earphone and the like, and the audio output unit performs a mute processing for breaking output of the audio when the stopping state of the display is released as the channel selection instruction is issued. It is thereby possible to prevent a rough audio with which noise is mixed at the time of the channel selection.

### BRIEF DESCRIPTION OF THE DRAWINGS

FIG. 1 is a diagram showing a configuration of a cellular phone of an embodiment;

FIG. 2 is a perspective diagram showing the cellular phone in-use;

FIG. 3 is a diagram showing a back side of a package of the cellular phone;

FIG. 4 is a flowchart showing an operational procedure of the cellular phone in receiving the AM radio broadcast;

FIG. 5 is a diagram showing two divided regions included in a main screen of the display;

FIG. 6 is a diagram showing a specific example where the contents of the AM radio broadcast is displayed on one divided region;

FIG. 7 is a diagram showing preferable arrangement of bar antenna corresponding to the case 1 and relationship between the bar antenna and the main screen;

FIG. 8 is a diagram showing preferable arrangement of bar antenna corresponding to the case 1 and relationship between the bar antenna and the main screen;

FIG. 9 is a diagram showing preferable arrangement of bar antenna corresponding to the case 2 and relationship between the bar antenna and the auxiliary screen;

FIG. 10 is a diagram showing preferable arrangement of bar antenna corresponding to the case 2 and relationship between the bar antenna and the auxiliary screen;

FIG. 11 is a flowchart showing an operational procedure of an exemplary modification of the cellular phone in receiving the AM radio broadcast; and

FIG. 12 is a flowchart showing an operational procedure of another exemplary modification of the cellular phone in receiving the AM radio broadcast.

### BEST MODE FOR CARRYING OUT THE INVENTION

A cellular phone with an AM radio of an embodiment to which the present invention is applied will be described in detail below with reference to the drawings. FIG. 1 is a diagram showing a configuration of a cellular phone of the embodiment. As shown in FIG. 1, a cellular phone 100 of the embodiment includes a cellular phone unit 10, an antenna 12, a speaker 14, a microphone 16, a power supply circuit 18, an AM radio tuner section 20, a bar antenna 22, an audio output section 24, a speaker 26, an operating section 30, displays 32, 34, a vibration generating section 36 and a control section 40. In the embodiment, the cellular phone unit 10, the power supply circuit 18, the AM radio tuner section 20, the audio output section 24, and the control section 40 are formed on a semiconductor substrate as a one-chip component with using a CMOS process.

The cellular phone unit 10 performs processings required for making a call or sending/receiving a mail with another cellular phone, a fixed-line phone or the like by using the cellular phone 100 as a portable telephone. Specifically, a waiting processing, a line connect processing and a speech processing performed by sending/receiving a electric wave of a predetermined frequency with a base station (not shown) via the antenna 12, and mail sending/receiving processings for sending/receiving mail with a mail server (not shown) connected via the base station. A power supply circuit 18 is for supplying operating power to the cellular phone unit 10. In the embodiment, only the operation of the cellular phone unit 10 can be stopped independent of the operation of the entire cellular phone 100. For example, the operation can be stopped when supplying the operating power by the power supply circuit 18 is stopped.

The AM radio tuner section 20 receives an AM radio broadcast by using the bar antenna 22 whose magnetic core is wound with a coil and demodulates the broadcast, and outputs an audio signal corresponding to the broadcast contents. The audio output section 24 is an audio outputting unit for amplifying an audio signal output from the AM radio tuner section 20 and outputs it from the speaker 26. An earphone may be used instead of or together with the speaker 26. When a mute signal is inputted, the audio output section 24 performs a mute processing for muting the output audio.

The operating section 30 is an operating unit having various keys needed at the time of start and stop receiving the AM radio broadcast in addition to the numeral keys required for inputting a phone number, the “*” key and the “#” key. For example, the operating section 30 has a channel selection key for causing the frequency to shift up or down, which is required for channel selection in receiving an AM radio broadcast, and a volume key for increasing or decreasing the output volume. Dedicated keys may be allocated to these keys, or a part of a numeric keypad and the like may serve that purpose. The operating section 30 also has various keys required for inquiring the mail server about the reception of any new mail or for sending and receiving mail.

The display 32 on one side has a big screen for displaying various types of information required for operations of the cellular phone 100. For example, it displays a telephone number of the other party in making a phone call, a calling image and the caller's phone number in receiving a phone call, an image indicating the remaining amount of an internal battery, an antenna mark indicating the strength of the electric wave transmitted from the base station, a receiving frequency and a volume of output audio in receiving an AM radio broadcast or the like. In the mail sending/receiving processes, the contents of the mail being created or the contents of the mail being received are displayed on the display 32. In the embodiment, the cellular phone 100 with a folding package is used.

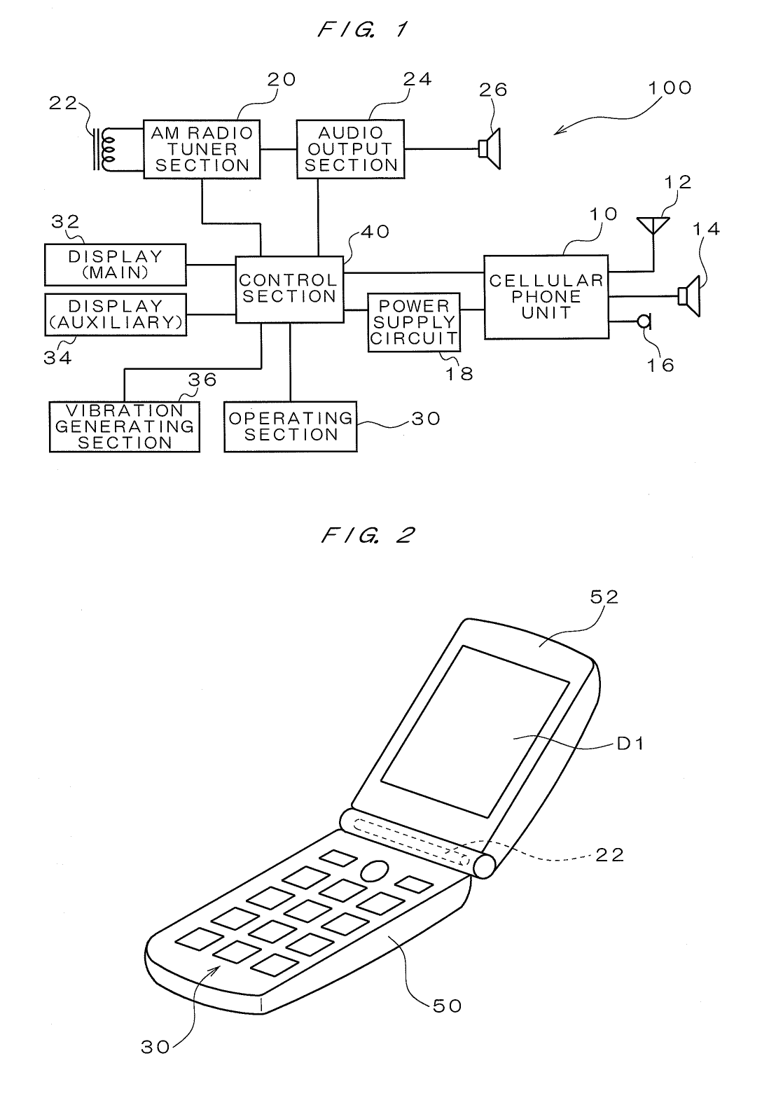

FIG. 2 is a perspective diagram showing the cellular phone 100 in-use. The cellular phone 100 has a package 50 having an operating section 30 which is mounted on one surface thereof and a package 52 having a display 32 which is mounted on one surface thereof. One end of longitudinal side of the package 50 and one end of longitudinal side of the package 52 are connected in foldable state so as to be able to open and close. As shown in FIG. 2, the numeral keys on the operating section 30 provided on the package 50 can be operated while the screen on the display 32 provided on the package 52 is being viewed, when the two packages 50 and 52 are opened. The screen of the display 32 can be checked for the display contents when a phone call is made, and it is referred as a “main screen” (D1) in following explanations.

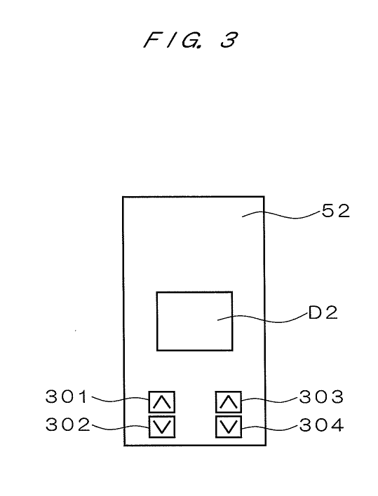

The other display 34 is arranged where it can be seen when the two packages 50 and 52 are in folded state. The display 34 has a screen smaller than the main screen and displays various types of information required for operations of the cellular phone 100 in a supplementary manner. For example, a calling image when a phone call is received, a receiving frequency and a volume of output audio in receiving an AM radio broadcast are displayed. The screen of the display 34 is referred as an “auxiliary screen” (D2) hereinafter. FIG. 3 is a diagram showing a back side of the package 52, on which an auxiliary screen D2 of the display 34 is provided substantially in the center.

For both of the abovementioned two displays 32, 34, color liquid crystal display devices using TFT (Thin Film Transistor) for active devices driven by an active matrix are used. The color liquid crystal display device has a feature of a fast response and vivid color reproduction, which are noise sources for the AM radio tuner section 20. As such, in the embodiment, when the AM radio broadcast is received by using the AM radio tuner section 20, control is carried out for changing the display state of the displays 32, 34.

The vibration generating section 36 vibrates the packages 50, 52 of the cellular phone 100. The control section 40 controls whole of the operations of the cellular phone 100. For example, when an AM radio broadcast is received, control for changing the receiving frequency of the AM radio tuner section 20 is performed in response to the operation of the channel selection key of the operating section 30, or for controlling to make a gain in the audio output section 24 to be variable is performed in response to the operation of the volume key. Also, controlling operations of displaying the receiving frequency or the output volume of the receiving AM radio broadcast is performed. The control section 40 operates as a display state controlling unit for changing the display states of the displays 32, 34 in commencing the reception of the AM radio broadcast, a telephone function stopping unit for stopping the operation of the cellular phone unit 10, a mail confirmation instruction unit for inquiring the mail server about the reception of new mail, and a mail reception notifying unit for notifying the reception of new mail when the mal is received.

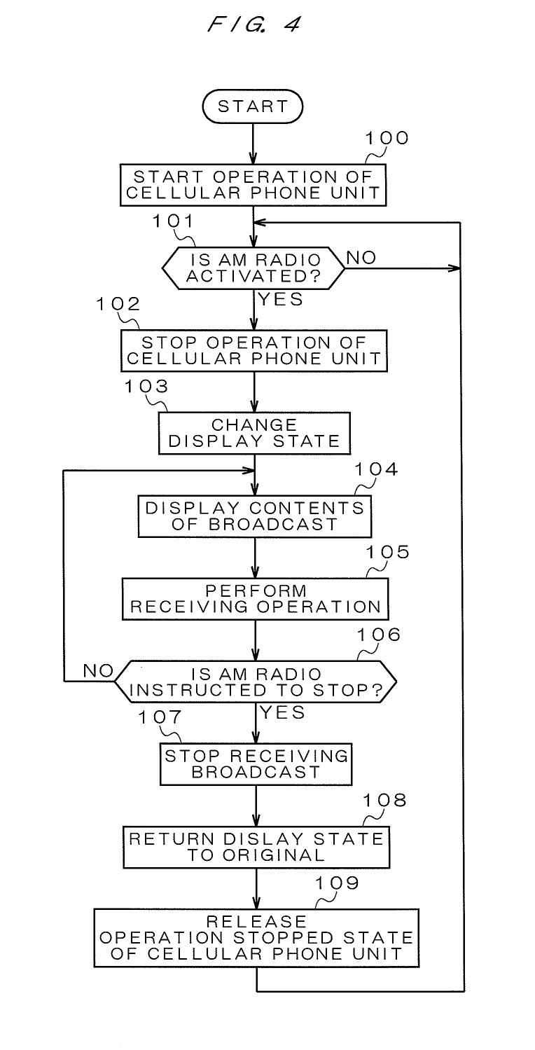

The cellular phone 100 of the embodiment has such a configuration, the operation of which will be described below. FIG. 4 is a flowchart showing an operational procedure of the cellular phone 100 in receiving the AM radio broadcast. When the cellular phone 100 is turned on and starts the operations, the control section 40 first sends an instruction to the power supply circuit 18 and starts supplying operating power to the cellular phone unit 10. The cellular phone unit 10 starts operation thereafter (step 100).

Next, the control section 40 determines whether the AM radio is activated or not (step 101). In this step, it is determined whether the instruction to activate the AM radio (instruction to commence the reception) is done or not by the user by means of the operating section 30. The instruction to activate the AM radio can be done not only by pressing keys dedicated for activating the AM radio provided for the operating section 30 but also by providing an instruction to activate the AM radio by operating the operating section 30 as viewing the hierarchical menu screen. When the user does not provide the instruction to activate, a negative determination is made in the step 101 and the judgment is repeated.

When the instruction to activate the AM radio is provided, an affirmative determination is made in the step 101, and then the control section 40 sends the instruction to the power supply circuit 18 to stop supplying operating power and stops the operation of the cellular phone unit 10 (step 102), and then changes the display states of the displays 32, 34 (step 103). Then, the control section 40 displays the contents of the AM radio broadcast to be received (step 104), while sending an instruction to the AM radio tuner section 20 to perform the operation of receiving the AM radio broadcast (step 105). Details of the operation of changing the display state at the step 103 will be described later.

In parallel to the operation of receiving the AM radio broadcast, the control section 40 determines whether it is instructed to stop the AM radio or not (step 106). A user can provide the stop instruction (instruction to stop receiving) by operating the operating section 30. If the user does not provide a stop instruction, a negative determination is made in the step 106, then the procedure returns to the step 104 and procedures after the displaying the contents of the broadcast are repeated.

When a stop instruction for the AM radio is provided, an affirmative determination is made in the step 106. Then, the control section 40 sends the instruction for the AM radio tuner section 20 to terminate the operation of receiving the AM radio broadcast (step 107). Next, the control section 40 returns the display state of the displays 32, 34 to the original state (step 108), while sending the instruction to the power supply circuit 18 to start supplying operating power and releases the operation stopped state of the cellular phone unit 10 (step 109), and returns to the step 101 and repeats the judgment whether the AM radio is activated or not.

Next, operations of changing the display state of the displays 32, 34 that are performed when the AM radio is activated will be described in detail. The display state is changed in order to reduce noises caused by the displays 32, 34 when the AM radio is received. There may be certain cases depending on which of the display 32 or the display 34 should be changed in its display state or how it is changed. The main two cases will be described below.

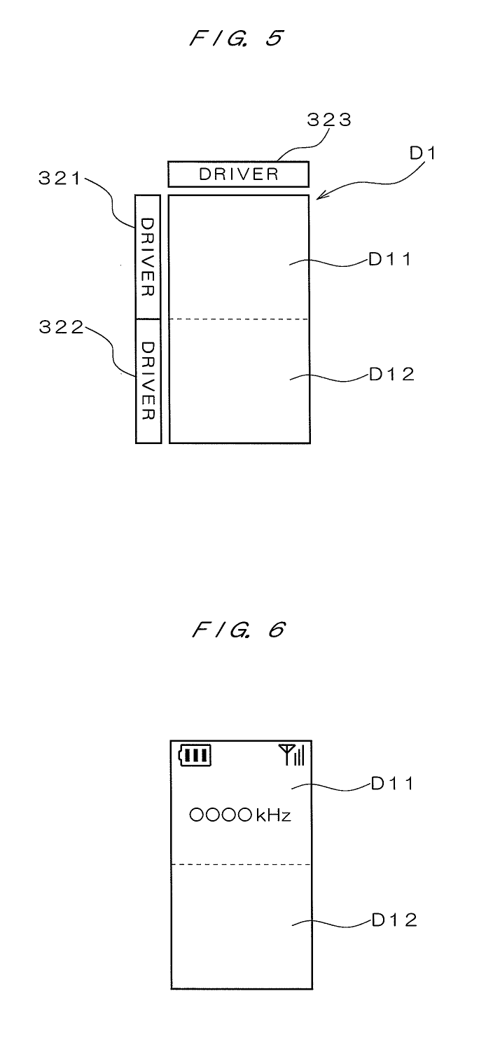

(Case 1) This is a case for dividing the main screen into multiple regions, displaying the contents of the AM radio broadcast by using only one of divided regions and stopping the operation of displaying in the other regions. FIG. 5 is a diagram showing two divided regions D11 and D12 included in the main screen D1 of the display 32. For example, the main screen D1 in a rectangular shape is divided into two by the divided regions D11 and D12 in lengthwise. As shown in FIG. 5, the display 32 is provided with two drivers 321 and 322 for scanning along the long side for displaying various types of information on the main screen D1 and a driver 323 for data along the short side. The driver 321 which is one of the drivers for scanning corresponds to one of the divided regions D11, while the other driver 322 corresponds to the other of the divided regions D12. When the AM radio broadcast is received, the drivers 321 and 323 are used and display is performed on only one of the divided regions D11. At this moment, the driver 322 is in a pausing state, in which no voltage is applied to the other divided region D12. The backlight is also divided in correspondence with each of the divided regions D11 and D12. It is controlled to turn out the backlight in correspondence with the divided region D12 in the pausing state.

FIG. 6 is a diagram showing a specific example where the contents of the AM radio broadcast is displayed on one of the divided regions D11. On one of the divided regions D11, a receiving frequency (XXXX KHz) is displayed as the contents of the AM radio broadcast being received at that moment is displayed. The name of the broadcast station may be displayed instead of the receiving frequency. The other divided region D12 at the moment is in the non-displayed state.

The auxiliary screen D2 of the display 34 displays the contents of the AM radio broadcast only on one of the divided regions which is also divided into two same as the main screen D1 is, while the other divided region enters in the non-displayed state. As the main screen D1, which has a bigger area, may mainly cause a noise source, only the main screen D1 is subject to the display control as shown in the case 1, and the display state using the entire screen may be kept for the auxiliary screen D2. Alternatively, the entire auxiliary screen D2 may be controlled into the non-display state by making only the main screen D1 to be used to perform various operations when the AM radio is used.

(Case 2) This is a case for stopping displaying of the main screen D1 and for displaying the contents of the AM radio broadcast only on the auxiliary screen D2. In such a case, as the main screen D1, being a big noise source, is in the non-active state, the noises can be substantially reduced. In this case, it is required that selection of receiving frequency or the like should be done by viewing only the auxiliary screen D2. Therefore, as shown in FIG. 3, some operation keys 301, 302, 303 and 304 of the operating section 30 are arranged on the same surface on which the auxiliary screen D2 is provided. For example, the operation keys 301 and 302 are used to shift up and down the receiving frequency, while the operation keys 303 and 304 are used to turn up and down the volume of the AM radio broadcast.

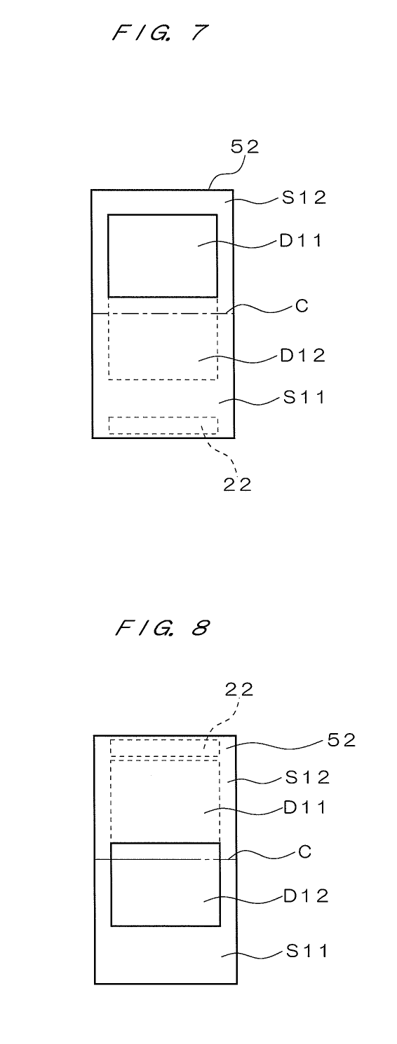

Hereinafter, relationship between the displays 32, 34 and the bar antenna 22 will be described. The bar antenna 22 is desirably placed apart from the displays 32, 34, which are noise sources. FIGS. 7 and 8 are diagrams showing preferable arrangement of the bar antenna 22 corresponding to the case 1 and relationship between the bar antenna 22 and the main screen. The surface of the package 52 is divided by center line C which is connecting each middle point of the long sides thereof into two spaces S11 and S12. As shown in FIG. 7, if the divided region D11, which is in a displaying state, is included in the space S12, the bar antenna 22 is arranged in the other space S11. Specifically, the bar antenna 22 is arranged at the end of the package 52 that is most apart from the divided region D11, which is in a displaying state. Alternatively, as shown in FIG. 8, if the divided region D12, which is in a displaying state, is placed across the center line C and more than half of the divided region D12 is placed in the space S11, the bar antenna 22 is arranged in the other space S12. In such a case, the bar antenna 22 is arranged at the end of the package 52 that is most apart from the divided region D12, which is in a displaying state.

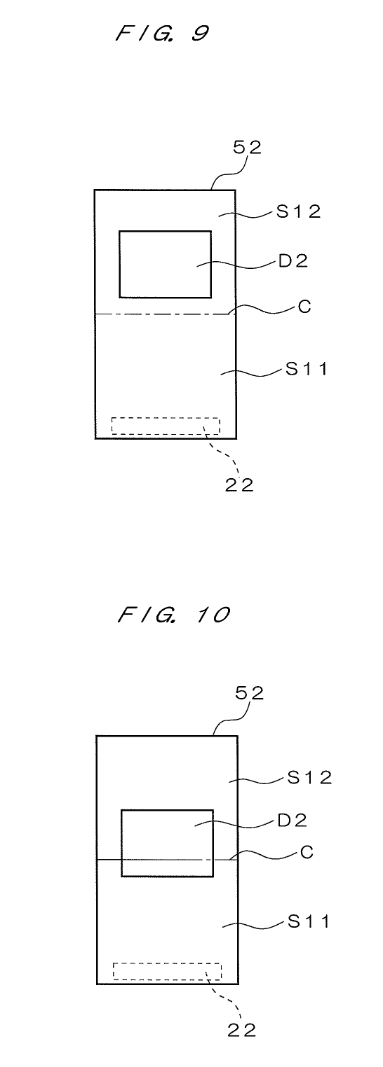

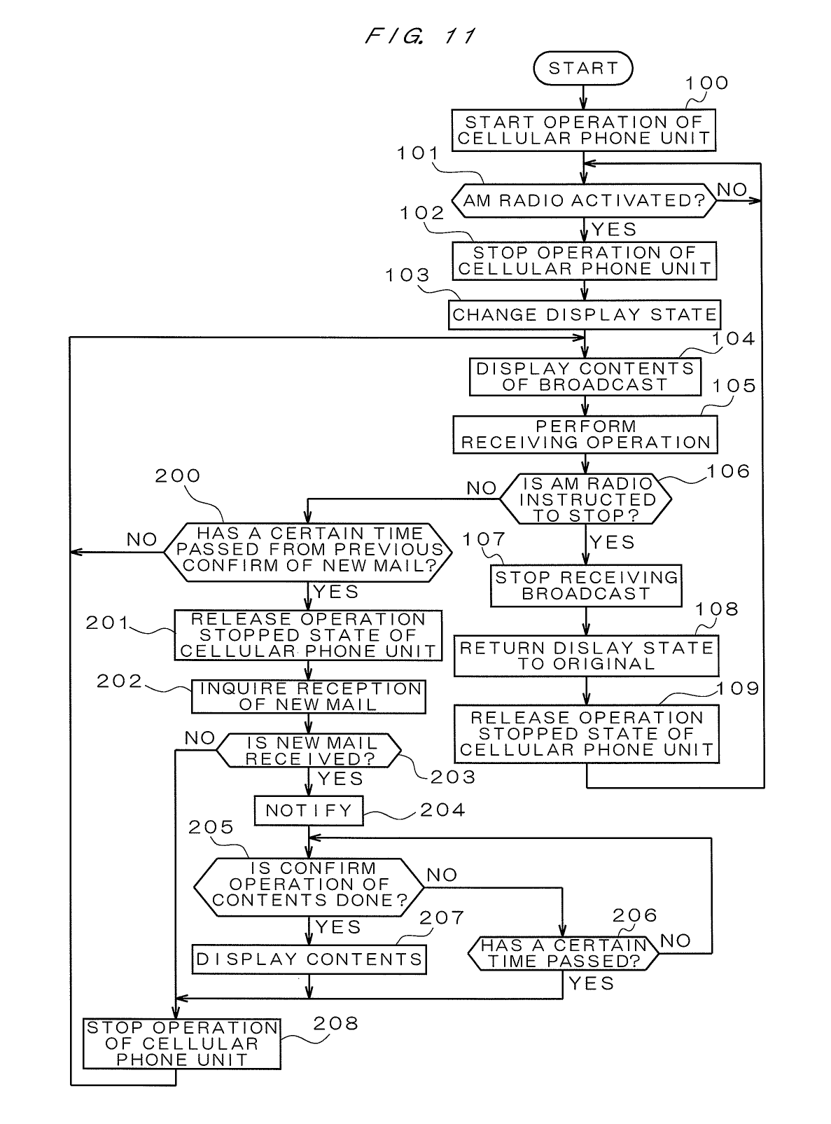

FIGS. 9 and 10 are diagrams showing preferable arrangement of the bar antenna 22 corresponding to the case 2 and relationship between the bar antenna 22 and the auxiliary screen. The surface of the package 52, which is including the auxiliary screen D2, is divided into two spaces S11 and S12 by center line C of the long sides of the package 52. As shown in FIG. 9, if the auxiliary screen D2 is included in the space S12, the bar antenna 22 is arranged in the other space S11. Specifically, the bar antenna 22 is arranged at the end of the package 52 that is most apart from the auxiliary screen D2. Alternatively, as shown in FIG. 10, if the auxiliary screen D2 is placed across the center line C and more than half of the auxiliary screen D2 is placed in the space S12, the bar antenna 22 is arranged in the other space S11.

As described above, it is possible to eliminate the noise mixed into the output audio of the AM radio broadcast from the AM radio tuner section 20 along with the operation of the cellular phone unit 10 by stopping the operation of the cellular phone unit 10 when the instruction to commence the reception of the AM radio broadcast is provided. Particularly, though the cellular phone needs to be turned off in public facilities such as on the train on in the hospital, only the operation of the cellular phone unit 10 can be stopped independent of the operation of the entire cellular phone 100 in the embodiment. Thus, it is not required to turn of the cellular phone 100, therefore the AM radio can be listened even at the places in which it is forbidden to use the cellular phone.

Further, it is possible to stop the operation of the cellular phone unit 10 only when the AM radio is used and to reduce the trouble in releasing the operation stopped state by releasing the operation stopped state of the cellular phone unit 10.

Further, as the displayed state of the displays 32, 34 is changed, the noise to be mixed with the output audio of the AM radio caused by the displays 32, 34 as noise sources can be reduced. Particularly, a color liquid crystal display device driven by an active matrix of the TFT type is often used in the cellular phone 100 of these days in consideration of improvement of the vividness of the display and the fast response. But there is a well known problem that the color liquid crystal display device becomes a noise source for the AM radio tuner section 20 bigger than the liquid crystal display device driven by a segment electrode that performs monotone display. However, in case where the color liquid crystal display device are used for the displays 32, 34, in the invention, the noise included in the output audio of the AM radio can be reduced by means of changing the display state. Furthermore, size of the display is getting bigger and bigger these days, it is inevitable to have a noise caused by operations of the displays 32, 34 occurred, however, the noise can be reduced by changing the display state of the displays 32, 34 when the AM radio is used.

In a specific example, the display 32 (or the display 34) has a plurality of divided regions D11, D12 that can selectively stop display operations; and the control section 40 stops display operation of one of the divided regions when an instruction to commence the reception of the AM radio broadcast is provided (when the AM radio is activated). Thus, the area of the display as a noise source can be reduced, thereby it is possible to reduce the amount of noise included in the AM radio output audio. In this example, information on the broadcast contents is displayed on the other divided region on which display operation dose not stop. Therefore both noise reduction and improvement of operability when the AM radio is used can be achieved. Further, since the bar antenna 22 for the AM radio is placed apart from a divided region in which display operation is performed, it can reduce the noise that enters via the bar antenna 22 when the AM radio broadcast is received.

Alternatively, in another specific example, the display 32 with a main screen and the display 34 with an auxiliary screen are arranged apart from each other, and the control section 40 stops the display operation of the display 32 when the AM radio is activated. It makes possible to reduce the entire display area of the displays 32, 34 as the noise source, thereby it is possible to reduce the amount of noise included in the AM radio output audio. Specifically, it can eliminate the biggest noise source by stopping display operation of the display 32, which has the biggest display area, thus, it can efficiently reduce the noise.

Although the operation of the cellular phone unit 10 is completely stopped when the AM radio broadcast is received in the description using the flowchart shown in FIG. 4, the inquiry for reception of new mail may be done for the mail server by temporary releasing the operation stopped state. That enables the user of the cellular phone 100 to receive a contact from a third party.

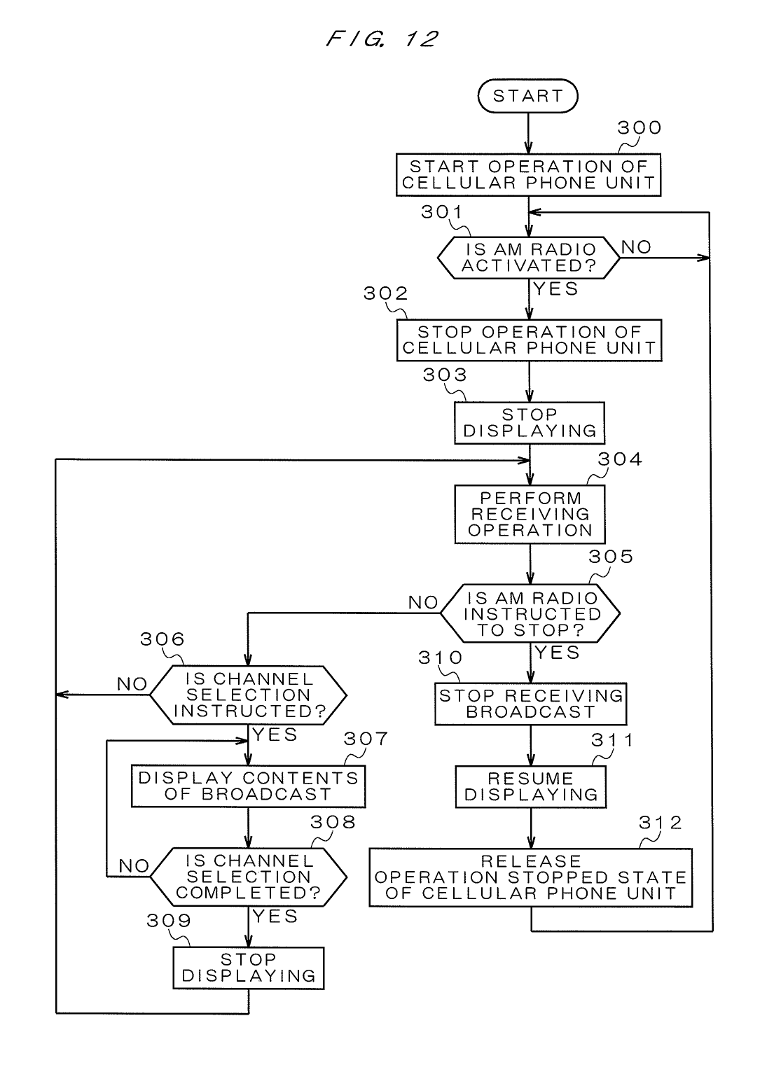

FIG. 11 is a flowchart showing an operation procedure when the new mail reception is periodically (predetermined repeating cycles) inquired when the AM radio broadcast is received. The flowchart shown in FIG. 11 differs from that in FIG. 4 in that operations at the steps 200 to 208 are added instead of immediately returning to the step 104 when a negative determination is made in the AM radio stop determination at the step 106. Each of the added steps will be described below.

If a negative determination is made in the step 106, the control section 40 determines whether a certain time has passed from the previous confirmation (inquiry) of the reception of new mail (step 200). If the certain time has not passed, a negative determination is made and the operation returns to the step 104, and a series of operation subsequent to displaying the broadcast contents is repeated. If the certain time has passed, an affirmative determination is made in the step 200, then the control section 40 sends the instruction to the power supply circuit 18 to start supplying the operating power and releases the operation stopped state of the cellular phone unit 10 (step 201), and then sends the instruction to the cellular phone unit 10 to inquire the mail server about the reception of new mail (step 202). The control section 40 determines about the presence of new mail from the result of the inquiry (step 203). If new mail is received, it does an affirmative determination and informs of the fact (step 204). For example, a message indicating that new mail is present is displayed on the displays 32 and 34 while the vibration generating section 36 makes vibration to the packages 50, 52 at the same time. Next, the control section 40 determines whether the user operates to confirm the contents of new mail by using the operating section 30 (step 205), and if this operation is not done, it does a negative determination. Then, it determines whether the certain time has passed or not (step 206). If the certain time has not passed yet, a negative determination is made and the judgment at the step 205 is repeated. If the operation to confirm the contents is done, an affirmative determination is made in the step 205. Then, the control section 40 displays the contents of the new mail on the displays 32, 34 (step 207). When the contents has been displayed or if the certain time has passed without the operation to confirm the contents being done (if an affirmative determination is made in the step 206), or if no new mail is present (if a negative determination is made in the step 203), the control section 40 sends the instruction to the power supply circuit 18 to stop supplying the operating power, and accordingly to stop the operation of the cellular phone unit 10 (step 208), the operation returns to the step 104 and the operations after the operation of displaying the broadcast contents are repeated.

As described above, whether the new mail, which is sent while the cellular phone unit 10 stops the operation, is received or not can be inquired at a predetermined time, it can minimize the disadvantages caused by disconnection of the contact by stopping the operation of the cellular phone unit 10. Particularly, inquiry about the reception of new mail is repeated in predetermined cycles, thereby the presence of mail can be correctly confirmed with a little time difference to the time when the mail is actually sent.

Further, after inquiring the mail server, if there any new mail, the reception of the new mail is notified to the user. This makes it possible to know the presence of new mail certainly even while the AM radio broadcast is received.

In case where no new mail is received, the operation of the cellular phone unit 10 is again stopped; and in case where new mail is received, the operation stopped state of the cellular phone unit 10 is prolonged until a predetermined operation is done. This eliminates the requirement to release the stopped cellular phone unit 10 each time when various operations involved in the reception of new mail should be done, including the operation of confirming the contents of the new mail and the operation of returning mail. Therefore, the various operations can be done in a short time.

Although inquiry about the reception of new mail is repeated to the mail server in predetermined cycles in the abovementioned description, the inquiry may be done by manual operation by the user. In such a case, the number of times to release the stopped cellular phone unit 10 can be reduced when the AM radio broadcast is received, and the presence of mail can be confirmed when the user wants to know.

Although the display state of the displays 32, 34 is controlled to have a small display area when the AM radio is used in the abovementioned embodiments, both of the displays 32, 34 may be controlled to be in the non-display state when the AM radio is used.

FIG. 12 is a flow chart showing an operational procedure of an exemplary modification of the cellular phone 100 when the AM radio broadcast is received. When the cellular phone 100 is turned on and starts the operations, the control section 40 first sends an instruction to the power supply circuit 18 and starts supplying operating power to the cellular phone unit 10. The cellular phone unit 10 starts operation thereafter (step 300). Next, the control section 40 determines whether the AM radio is activated or not (step 301). If the user does not provide an instruction to activate, a negative determination is made and the judgment is repeated. When an instruction to activate the AM radio is provided, an affirmative determination is made in the step 301, and then the control section 40 sends the instruction to the power supply circuit 18 to stop supplying operating power and stops the operation of the cellular phone unit 10 (step 302), and then changes the display states (to the non-display state) of the displays 32, 34 (step 303), while sending an instruction to the AM radio tuner section 20 to perform the operation of receiving the AM radio broadcast (step 304).

In parallel to the operation of receiving the AM radio broadcast, the control section 40 determines whether it is instructed to stop the AM radio or not (step 305). If the user does not provide an instruction to stop, a negative determination is made. Next, the control section 40 determines whether the channel selection instruction is done or not (step 306). For example, the user can perform the channel selection instruction by shifting up or down the receiving frequency arbitrarily with the operating section 30, or directly designating the receiving frequency with the numeral keys provided for the operating section 30. If the channel selection instruction is not provided, a negative determination is made in the step 306, and the operation returns to the step 304 and the operation of receiving the AM radio broadcast is repeated.

If the channel selection is instructed, an affirmative determination is made in the step 306. Then, the control section 40 temporally resumes displaying of the displays 32 and 34 that have stopped displaying, and displays the contents of the AM radio broadcast to be received (step 307). Although the operation of displaying the contents may be performed by using the entire displays 32, 34 (both of the main screen and the auxiliary screen), it is desirable to reduce a noise by using the display control of the abovementioned case 1 or case 2.

Then, the control section 40 determines whether the channel selection operation has been completed or not (step 308). For example, it is considered that the channel selection operation has been completed if the operating section 30 has not been operated for a predetermined time (for example, for a second) after it was operated to select a channel. If the channel selection operation has not been completed, a negative determination is made in the step 308, and the operation returns to the step 307 and the contents of the AM radio broadcast is kept displayed. When the channel selection operation is completed, the control section 40 stops displaying on the displays 32, 34 again (step 309), and then the operation returns to the step 304 and the operation of receiving the AM radio broadcast is repeated.

When a user provides an instruction to stop the AM radio, an affirmative determination is made in the determination at the step 305, and then the control section 40 sends the instruction to the AM radio tuner section 20 and ends the operation of receiving the AM radio broadcast (step 310), while resuming the displaying operation by the displays 32, 34 (step 311). Then, the control section 40 sends the instruction to the power supply circuit 18 to start supplying operating power and releases the operation stopped state of the cellular phone unit 10 (step 312), and returns to the step 301 and repeats determination on the AM radio activation.

As described above, when the AM radio is activated, the control section 40 of the embodiment stops the operation of the cellular phone unit 10 and also stops the displaying operation of the displays 32, 34 so that influences of the cellular phone unit 10 and the displays 32, 34 as noise sources can be avoided. Therefore, occurrence of noises caused by them can be eliminated. Moreover, as a stopped state of the displaying operation of the displays 32, 34 are temporally released when the channel selection instruction is provided, both effects of improvement of operability and noise reduction can be achieved only by performing the requisite minimum display when the channel selection is done. Particularly, the noise temporally included in the output audio at the time of channel selection can be reduced by releasing the stopped state of the displaying operation for a part of the displayed region of the entire displays 32, 34 (when display control of cases 1, 2 is used in parallel).

The present invention is not limited to the abovementioned embodiments and various modifications are possible within a scope of the spirit of the present invention. For example, although the cellular phone 100 having two displays 32, 34 are described in the abovementioned embodiments, three or more displays may be provided. The control of the display state corresponding to the case 2 in this example, for an instance, it is desirable to keep displaying only with the smallest display area and stops display operation of the other displays. That can minimize the noise even if many displays are provided.

In the operation procedure described with reference to FIG. 11, a mute signal may be input from the control section 40 into the audio output section 24 to make a mute processing for output audio of the AM radio, when displaying is temporally resumed at the time of the channel selection. Since the output audio is muted by the mute processing, it can be prevented from outputting the rough sound includes noise caused by displaying temporally resumed. Actually, the contents of the AM radio broadcast may often be output improperly at the time of the channel selection because of frequency sweeping. Therefore, it may not be serious problem even if the mute processing is performed at the time of the channel selection.

According to the present invention, it is possible to reduce noise mixed into the output audio of the AM radio broadcast along with the operation of the cellular phone unit. Particularly, though the cellular phone needs to be turned off in public facilities such as on the train or in the hospital, only the operation of the cellular phone unit can be turned off when the AM radio broadcast is received in the cellular phone of the invention. Thus, the AM radio can be listened even at the places in which it is forbidden to use the cellular phone.

1. A cellular phone with an AM radio comprising:
a cellular phone unit for performing a waiting processing, a line connect processing and a speech processing performed by sending/receiving an electric wave with a base station;
an AM radio tuner unit for receiving AM radio broadcast and outputting a demodulated audio signal; and
a telephone function stopping unit for stopping operation of said cellular phone unit when said AM radio tuner unit is operating.

2. The cellular phone with an AM radio according to claim 1, further comprising:
an operating unit for providing an instruction to commence the reception of the AM radio broadcast by said AM radio tuner unit;
wherein the reception operation of the AM radio broadcast by said AM radio tuner unit is commenced while operation of said cellular phone unit is stopped by said telephone function stopping unit when said instruction to commence the reception is provided by using said operating unit.

3. The cellular phone with an AM radio according to claim 2, wherein
an instruction to finish the reception of the AM radio broadcast by said AM radio tuner unit is provided by using said operating unit; and
said telephone function stopping unit releases the operation stopped state of said cellular phone unit when said instruction to finish the reception is provided.

4. The cellular phone with an AM radio according to claim 1,
wherein said cellular phone unit performs mail sending/receiving processings for sending or receiving mail with a mail server connected via the base station;
said cellular phone further comprising a mail confirmation instruction unit for providing a confirmation instruction to said cellular phone unit for inquiring said mail server about the reception of new mail by temporally releasing the operation stopped state of said cellular phone unit at a predetermined time when said AM radio tuner unit is operating and when operation of said cellular phone unit stops.

5. The cellular phone with an AM radio according to claim 4,
wherein the confirmation instruction by said mail confirmation instruction unit is repeatedly performed in predetermined cycles.

6. The cellular phone with an AM radio according to claim 4,
wherein the confirmation instruction by said mail confirmation instruction unit is performed according to a manual operation of a user.

7. The cellular phone with an AM radio according to claim 4, further comprising:
a mail reception notifying unit for notifying that new mail is received if there any new mail upon an inquiring said mail server about the reception of new mail.

8. The cellular phone with an AM radio according to claim 4,
wherein upon inquiring said mail server about whether new mail is received or not, said telephone function stopping unit performs operation stopping of said cellular phone unit again, if new mail is not received; and prolongs the stopped state of operation of said cellular phone unit until predetermined operations are done, if new mail is received.

9. The cellular phone with an AM radio according to claim 8,
wherein said predetermined operations are operation of confirming the contents of new mail and operation of returning mail.

10. The cellular phone with an AM radio according to claim 1, further comprising:
a display unit for displaying the operational contents of said cellular phone unit and the operational contents of said AM radio tuner unit; and
a display state controlling unit for changing the display state of said display unit when said instruction to commence the reception is provided by using said operating unit.

11. The cellular phone with an AM radio according to claim 10, wherein said display unit is a color liquid crystal display device.

12. The cellular phone with an AM radio according to claim 10,
wherein said display state controlling unit changes the display state of said display unit so as to reduce the noise to be mixed with said AM radio tuner unit from said display unit.

13. The cellular phone with an AM radio according to claim 10,
wherein said display unit has a plurality of divided regions where display operation can be selectively stopped, and
wherein said display state controlling unit stops the display operation of a part of said plurality of divided region when said instruction to commence the reception is provided.

14. The cellular phone with an AM radio according to claim 13,
wherein said AM radio tuner unit has a bar antenna whose magnetic core is wound with a coil, and remaining of said divided regions in which display operation is not stopped are arranged in one of the spaces separated in the middle of longitudinal sides in a package having a solid shape oblong in one direction, and said bar antenna is arranged apart in other space.

15. The cellular phone with an AM radio according to claim 13,
wherein said AM radio tuner unit has a bar antenna whose magnetic core is wound with a coil, and more than half of said remaining divided regions in which display operation is not stopped are arranged in one of the spaces separated in the middle of longitudinal sides in a package having a solid shape oblong in one direction, and said bar antenna is arranged apart in other space.

16. The cellular phone with an AM radio according to claim 13,
wherein said AM radio tuner unit has a bar antenna whose magnetic core is wound with a coil, and said bar antenna is arranged along the edge of said package that is most apart from said remaining divided regions in which display operation is not stopped in a package having a solid shape oblong in one direction.

17. The cellular phone with an AM radio according to claim 10,
wherein said display unit has a plurality of display regions which are set in different spaces, and
wherein said display state controlling unit stops the display operation of a part of said plurality of display region when said instruction to commence the reception is provided.

18. The cellular phone with an AM radio according to claim 17,
wherein said display state control unit stops display operation of said display region with the biggest area.

19. The cellular phone with an AM radio according to claim 17,
wherein said display state control unit stops operation of said display regions except for said display region with the smallest area.

20. The cellular phone with an AM radio according to claim 17,
wherein said AM radio tuner unit has a bar antenna whose magnetic core is wound with a coil, and remaining of said divided regions in which display operation is not stopped are arranged in one of the spaces separated in the middle of longitudinal sides in a package having a solid shape oblong in one direction, and said bar antenna is arranged apart in other space.

21. The cellular phone with an AM radio according to claim 17,
wherein said AM radio tuner unit has a bar antenna whose magnetic core is wound with a coil, and more than half of said remaining divided regions in which display operation is not stopped are arranged in one of the spaces separated in the middle of longitudinal sides in a package having a solid shape oblong in one direction, and said bar antenna is arranged apart in other space.

22. The cellular phone with an AM radio according to claim 17,
wherein said AM radio tuner unit has a bar antenna whose magnetic core is wound with a coil, and said bar antenna is arranged along the edge of said package that is most apart from said remaining divided regions in which display operation is not stopped in a package having a solid shape oblong in one direction.

23. The cellular phone with an AM radio according to claim 10,
wherein said display state controlling unit stops the display operation of display unit when said instruction to commence the reception is provided.

24. The cellular phone with an AM radio according to claim 23,
wherein a channel selection instruction for switching a receiving frequency of a broadcasting wave to be received by said AM radio tuner unit is performed by using said operating unit; and
said display state controlling unit temporally releases a stopped state of the display operation of said display unit when said channel selection instruction is provided.

25. The cellular phone with an AM radio according to claim 24,
wherein the stopped state of the display operation of said display unit is released for a part of the entire display regions of said display unit.

26. The cellular phone with an AM radio according to claim 24, further comprising:
an audio output unit for outputting an audio corresponding to an audio signal output from said AM radio tuner unit from a speaker or an earphone;
wherein said audio output unit performs a mute processing for breaking output of the audio when the stopped state of display operation of said display unit is released as said channel selection instruction is provided.
